(19) United States
(12) Patent Application Publication
(10) Pub. No.: US 2006/0108774 A1
(43) Pub. Date: May 25, 2006

(54) Wagon for remodeling industry

(76) Inventor: Joseph Raymond, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/283,139

(22) Filed: Nov. 18, 2005

Related U.S. Application Data
(60) Provisional application No. 60/629,671, filed on Nov. 19, 2004.

(51) Int. Cl. B62B 1/00

(52) U.S. Cl. 280/651

(57) ABSTRACT

An extendible utility wagon is extendable between a compact position and an extendable position. The extendable utility wagon includes a frame adapted to extend outwardly from the compact position to the extended position. A plurality of wheels is operatively connected to the frame. A wagon handle is operatively connected to the frame for pulling the utility wagon.

### CROSS-REFERENCE TO RELATED APPLICATIONS

This application claims priority to U.S. Provisional Patent Application Ser. No. 60/629,671 filed Nov. 19, 2004, which is incorporated by reference herein in its entirety.

### FIELD OF THE INVENTION

The present invention relates generally to an utility wagon for use in a nursery, garden, or industry or for personal use.

### BACKGROUND OF THE INVENTION

The present invention relates to a wagon suitable for use in the remodeling industry. The present invention is not to be limited to use in the remodeling industry. However, as a manner of convenience and to explain some of the types of problems that the present invention addresses, problems associated with the remodeling industry are discussed.

In the remodeling industry, there is a need to move significant amounts of materials from one place to another. For example, the materials may be located in a truck or other vehicle and need to be moved to the remodeling site which may be in a building or elsewhere. Presently a remodelor will have to carry materials between locations. Some types of materials, such as paneling, sheet material, windows, and doors are large and unwieldy and therefore require more than one person to move. Thus, a great deal of time and effort is expended to move these materials. In addition, a remodelor may need to make multiple trips to move their materials and tools to and from a job site.

Several utility wagons to facilitate the transport of materials are known. One such wagon includes an utility wagon that is extensible in both length and width. (See U.S. Pat. No. 6,109,644, to Cox). While the extensible wagon is generally successful for accomodating materials of various sizes, a variety of potential disadvantages have been recognized with respect to the distribution of load weight and stabilization of the materials during transport. Because extensible wagons extend solely from an exterior end, the load weight is not evenly distributed across the length of the wagon, thereby increasing the difficulty of maneuvering the wagon, especially for heavy loads. Another disadvantage of the extensible wagon is that it may be difficult to transport bulky or awkward materials as the wagon does not allow for the stabilization of the materials being transported.

For these and other reasons, there is a need for the present invention.

### SUMMARY OF THE INVENTION

Therefore, it is a primary objective, feature or advantage of the present invention to improve upon the state of the art.

It is a further objective, feature or advantage of the present invention to provide a wagon suitable for use in the remodeling industry.

Yet another objective, feature or advantage of the present invention is to provide an extendable wagon or cart.

A further objective, feature or advantage of the present invention is to provide an extendable cart that is adapted to accommodate varying sizes of materials, including large panels or sheets.

Yet another objective, feature or advantage of the present invention is to provide a wagon that is adapted to be conveniently moved to remodeling job sites.

Another objective, feature or advantage of the present invention is to provide a wagon that distributes the load weight on the wheels.

A further objective, feature or advantage of the present invention is to provide a wagon that provides a fastening mechanism to secure the various materials being transported.

Still another objective, feature or advantage of the present invention is to provide a wagon that may be pushed or pulled manually.

Yet another objective, feature or advantage of the present invention is to provide a wagon that may be towed.

Yet another objective, feature or advantage of the present invention is to provide a wagon that telescopes to adjust the length of the wagon.

A still further objective, feature or advantage of the present invention is to provide a wagon that does not disturb landscaping.

One or more of these and/or other objectives, features or advantages of the present invention will become apparent from the specification and claims that follow.

The present invention includes an extendable utility wagon or cart suitable for numerous applications, including for use by the remodeling industry. The wagon is adapted to accommodate various sizes of materials and various types of materials and allows an operator to conveniently bring these materials directly to where the materials are to be used.

According to one aspect of the present invention, an extendable utility wagon has a frame. The frame includes a longitudinal support adapted to be extended outwardly to increase the length of the utility wagon. The frame also includes a plurality of traverse members traversing the longitudinal support. The frame further includes a plurality of wheels operatively connected to the frame. There is a wagon handle operatively connected to the frame for pulling the utility wagon.

According to another aspect of the present invention, the wagon includes a wagon body having a first end and a second end. The wagon body has a compact position and an extended position. In the extended position, the wagon body has a greater distance between the first end and the second end than in the compact position. The wagon body is adapted to accept upright supports to extend upwardly from the wagon body to accommodate carrying different size loads, including sheets or panels of materials. There is a wagon handle operatively connected to the wagon body that adapts the wagon to be pulled by an operator. Thus, a single operator can move loads which might otherwise require multiple individuals to move. The wagon also allows loads to be moved in a single trip that might otherwise require multiple loads by an operator.

### BRIEF DESCRIPTION OF THE DRAWINGS

FIG. 1 is an exploded perspective view illustrating one embodiment of the present invention.

FIG. 2 is a perspective view illustrating one embodiment of the present invention in an open position.

FIG. 3 is a perspective view illustrating one embodiment of the present invention in a closed position.

FIG. 4 is a perspective view illustrating one embodiment of the present invention configured to haul material such as drywall.

### DETAILED DESCRIPTION OF THE PREFERRED EMBODIMENT

The methods by which the objects, features and advantages of the present invention are achieved will now be described in more detail. These particulars provide a more precise description of the invention for the purpose of enabling one of ordinary skill in the art to practice the invention, but without limiting the invention to the specific embodiments described.

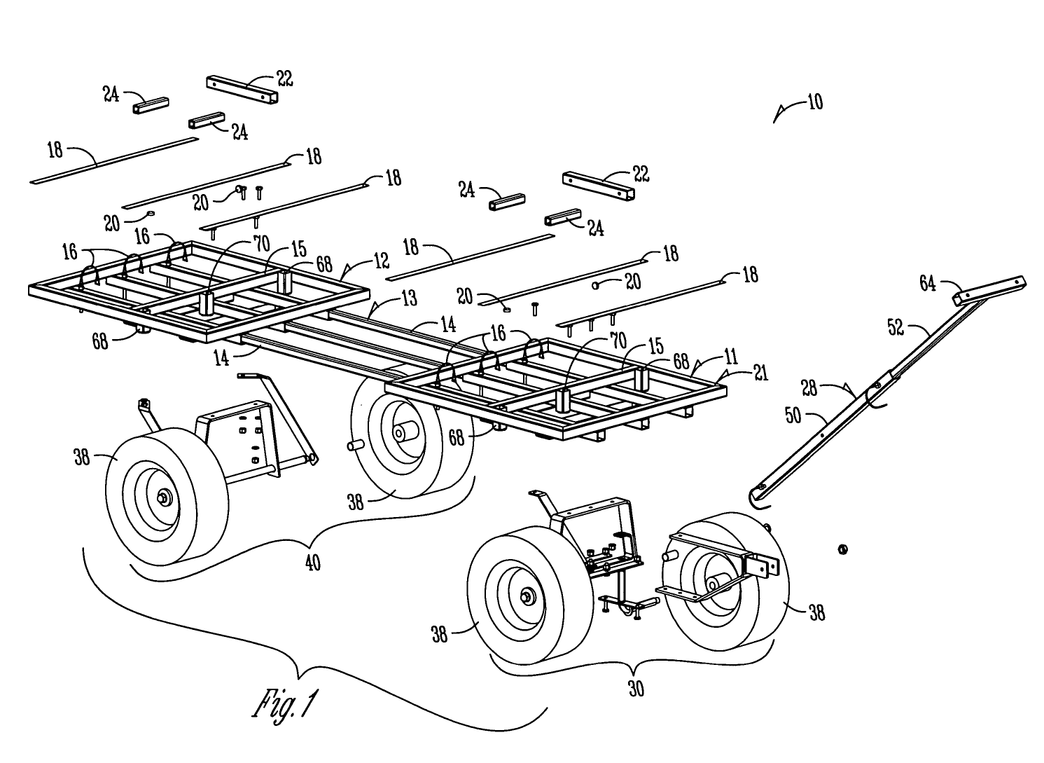

FIG. 1 illustrates one embodiment of a wagon 10 of the present invention. As shown in FIG. 1, the wagon 10 has a frame 11 which includes a front frame portion 21 and a rear frame portion 12. The front frame portion 21 and rear frame portion 12 extend inwardly and outwardly to alter the length of the wagon 10 so as to size the wagon 10 to accommodate loads of varying sizes. Preferably, the wagon 10 extends and retracts through the use of tube extensions 14 which allow the wagon 10 to extend and retract in a telescoping manner. Note that in the configuration shown, both the front frame portion 21 and the rear frame portion 12 can extend outwardly from the center independently of one another which provides additional flexibility in configuring the wagon 10 for various types of loads as the weight or position of the load can be positioned in different ways relative to the axle assemblies 30, 40 and handle 28 of the wagon 10.

The tube extensions 14 are a part of the longitudinal support members 13 of the frame 11. A number of traverse members 15 provide additional support for the load carried by the wagon 10. Thus, the frame 11 has one or more longitudinal support members 13 and a series of traverse members 15 traversing the longitudinal support 13. The longitudinal support members 13 includes hollow members as a part of the frame and at least one connecting bar or tube extension 14. The connecting bar fits inside opposing members and allows the bar to slide longitudinally, such that the horizontal distance or span between opposite ends of the wagon 10 can be adjusted. In a non-extended or compacted position, the bar 22 disappears horizontally into the members in the frame. In an extended position, the bar 22 slides out of the hollow members allowing the frame to extend longitudinally. The bar may be secured in place by using a fastening mechanism of various types, including the use of a clamp, pin, clip or other connector. Fasteners 16 such as pin and clips are shown so that once the front frame portion and the rear frame portion are positioned as desired, then can be fastened in place. Tube extension connectors 22 and tube pocket restraining members 24 are shown.

Anti-slip strips 18 are optionally operatively connected to the traverse members 15 to also assist in retaining a load. Self-adhesive magnets 20 are also shown. The present invention contemplates that other times of features can also be added that may assist with positioning and retaining a load for transport.

A front axle assembly 30 is shown which when assembled is operatively connected to the front frame portion. A rear axle assembly 40 is shown which when assembled is operatively connected to the rear frame portion. Two wheels 38 are operatively connected to each of the axle assemblies 30, 40.

A handle 28 is shown which includes a lower frame portion 50 and an upper frame portion 52 which is extendable relative to the lower frame portion, such as in a telescoping manner. A handle grip 64 is operatively connected to the handle 28.

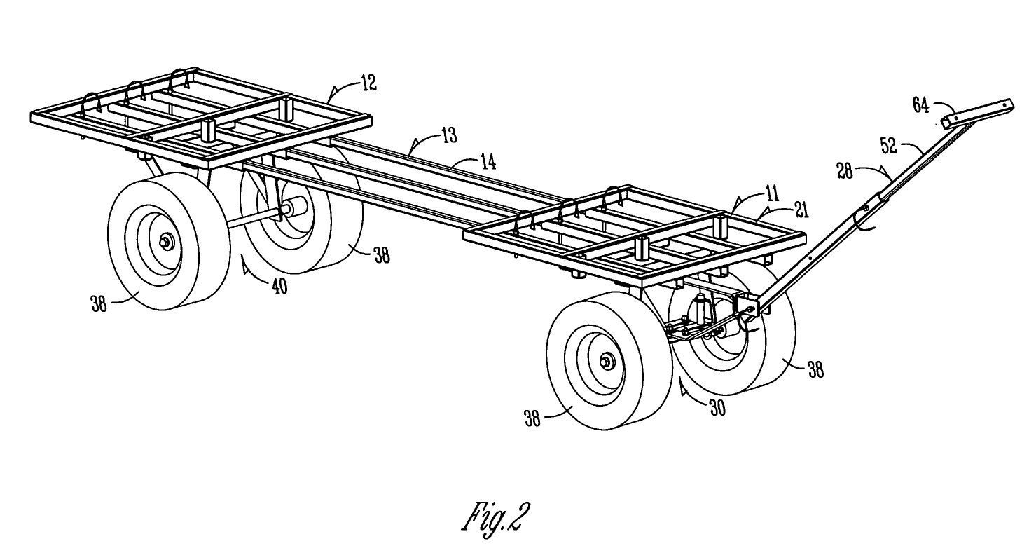

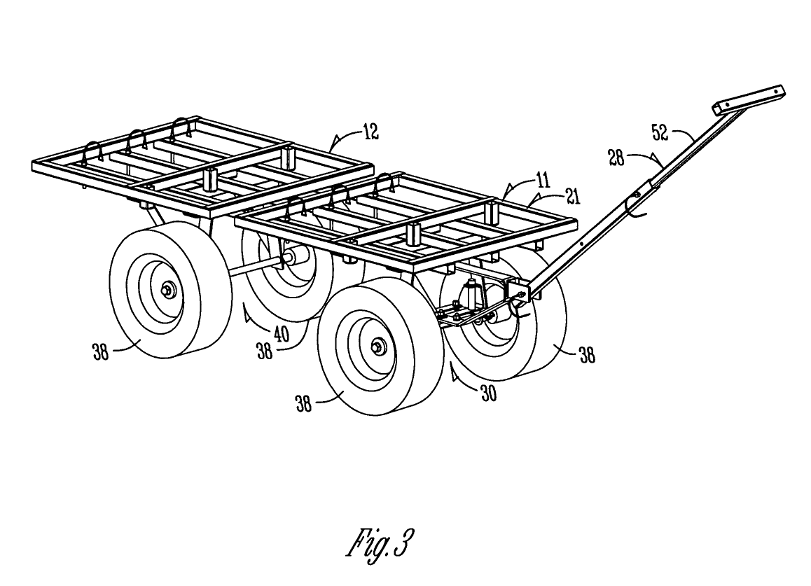

In operation, the wagon is pulled outwardly to extend the wagon. The wagon is then secured in place at the desired length. The present invention contemplates that the length of the wagon in the compact and in the extended position can vary widely. For example, in the compact position the length of the wagon may be four feet and the same wagon can have a length of twelve feet in the extended position. FIG. 2 illustrates one embodiment in an extended position while FIG. 3 illustrates one embodiment of the wagon in a compact position. Thus, the present invention contemplates that the wagon is highly adjustable to accommodate different sizes and shapes of loads. The present invention allows one or multiple connecting members to be used for extending the wagon.

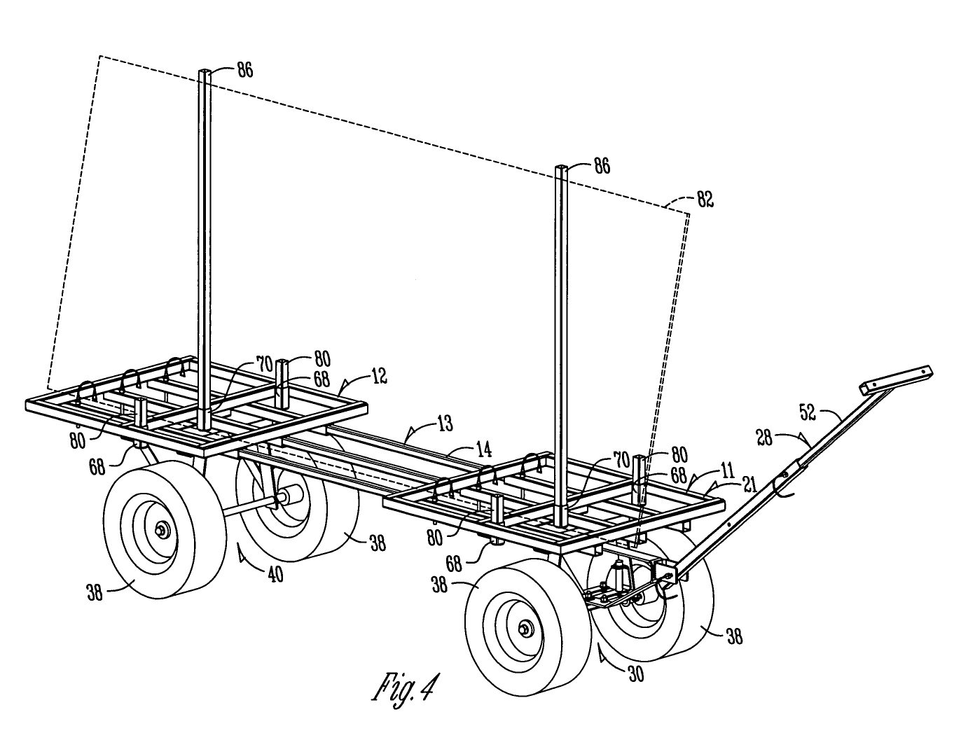

The present invention contemplates that the wagon can be adapted to accommodate variations in the type of load in other ways. For example, the wagon can be adapted to accommodate panels or sheets of material. To do so, the present invention may include one or more upright supports. A sheet or panel is angled between an edge of the frame of the wagon and the upright support. Preferably stop members are attached to the frame to retain the sheet or panel in place. In one embodiment, one or more upright supports are centrally located so that panels or sheets can be accommodated on both sides of the wagon. This embodiment is best shown in FIG. 4.

In FIG. 4, Upright support holders 70 are also shown as well as stop member holders 68. Stop members 80 are placed in the stop member holders 68 and upright support members 86 are placed in the upright support member holders 70. A panel 82 is shown being supported. Panels can be supported on either side of the upright support members holders 70.

Another feature of the present invention is to provide one or more fasteners for securing loads. Preferably, the fasteners are ratcheting straps; although the present invention contemplates that many other types of fasteners can be used. In another embodiment, the straps have two ends. The first end is secured to the frame of the wagon using a fastener, for example a screw, and the second end contains a buckle that is extendable to wrap around and secure the materials.

The frame is operably connected to a wheel assembly. The front wheels are rotatably coupled to the front end of the frame and the rear wheels are rotatably coupled to the back end of the frame, with the front wheels being pivotally coupled to the front end of the frame to allow the wagon to be steered. The wheels are mounted to the frame by respective axles. The front axle is connected to a handle to facilitate steering.

Various embodiments are also contemplated and other features may include a tailgate or other retaining structure on the end of the wagon, containers for holding remodeling supplies or other variations. The various members and components of the wagon may be manufactured from any number of types of materials. Although various aspects of the invention are described in detail, it will be apparent to one skilled in the art that modifications, substitutions, and additions may be made without departing from the spirit and scope of the invention. Therefore, the present invention is not to be limited to the specific embodiments shown or described herein, rather the present invention contemplates numerous variations in the specific structure or configuration of the present invention.

What is claimed is:

1. An extendable utility wagon, comprising:
a frame comprising (a) a longitudinal support adapted to be extended outwardly to increase length of the utility wagon, (b) a plurality of traverse members traversing the longitudinal support;
a plurality of wheels operatively connected to the frame;
a wagon handle operatively connected to the frame for pulling the utility wagon.

2. The extendable utility wagon of claim 1 wherein the longitudinal support telescopes outwardly.

3. The extendable utility wagon of claim 1 wherein the frame is adapted for receiving a load in an extended position.

4. The extendable utility wagon of claim 1 wherein the plurality of wheels includes four wheels.

5. The extendable utility wagon of claim 1 further comprising at least upright supports extending upwardly from the frame.

6. The extendable utility wagon of claim 5 further comprising at least one stop member associated with each of the at least one upright supports thereby adapting the extendable utility wagon for supporting at least one sheet of material position between the at least one stop member and the at least one upright support.

7. A wagon comprising:
a wagon body having a first end and a second end;
wherein the wagon body has a compact position and an extended position;
the extended position adapting the wagon body to have a greater distance between the first end and the second end than in the compact position.

8. The wagon of claim 7 wherein the wagon body is adapted to accept a plurality of upright supports to extend upwardly from the wagon body.

9. The wagon of claim 7 further comprising a wagon handle operatively connected to the wagon body adapting the wagon to be pulled by an operator.

10. An extendable utility wagon for transporting material, comprising:
a frame comprising (a) at least one longitudinal support adapted to be extended outwardly to increase length of the utility wagon, (b) a plurality of traverse members traversing the longitudinal support;
a plurality of wheels operatively connected to the frame;
a wagon handle operatively connected to the frame for pulling the utility wagon;
a first stop member and a second stop member on opposite sides of the frame;
at least one upright support substantially centered between the first stop member and the second stop member for stabilizing the materials between the upright support and at least one of the first stop member and the second stop member.
